(19) United States
(12) Patent Application Publication
(10) Pub. No.: US 2009/0055485 A1
(43) Pub. Date: Feb. 26, 2009

(54) LOCATION BASED ANONYMOUS INSTANT MESSAGE EXCHANGE METHOD AND SYSTEM

(76) Inventors: Tu-Hsin TSAI, Taipei (TW); Chia-I Lin, Taipei (TW); Chun-Tai Yen, Taipei (TW); Wei-Hsiang Hung, Taipei (TW)

Correspondence Address: SINORICA, LLC, 528 FALLSGROVE DRIVE, ROCKVILLE, MD, 20850, US

(21) Appl. No.: 11/843,385

(22) Filed: Aug. 22, 2007

(51) Int. Cl. G06F 15/16

(52) U.S. Cl. 709/206

(57) ABSTRACT

An anonymous instant messaging system that protects a user's identity and location while allowing numerous users to communicate without being acquainted is disclosed. To request information a user selects a geographical location and relevant topic. The user then sends the information request to a message bot via an instant messenger client. A user geographic and topic matching system provides an active matching users list to the message bot. The message bot then sends the information request message to all of the matching users. The matching users receive and read the information request from the message bot. If a user chooses to reply to the message, the user sends their response to the message bot. The user geographic and topic matching system gives the original question issuer's instant messenger identification to the message bot. The message bot passes the reply to the information request to the original question issuer.

### BACKGROUND OF THE INVENTION

1. Field of the Invention

The present invention relates to instant messaging. More specifically, the present invention discloses an instant message exchange system that allows users to exchange information while keeping user identities anonymous.

2. Description of the Prior Art

Users of conventional instant messaging clients can communicate with friends or families over a network or the internet. Some examples of these instant messaging clients are Microsoft Messenger, Yahoo! Messenger, and Google Talk.

Users use the instant messaging clients to connect to an instant messaging server. After connecting to the server a user can invite another user to participate in a real-time text conversation. Each user types a sentence or two into a text input box and then sends the text to the other user.

While instant messaging is useful for certain situations, if a user is not online and logged into the instant messaging service any messages sent by other users are not delivered. Therefore the information is lost. This is unlike email which is delivered immediately and sits in a user's in-box until the user chooses to open the email.

Also, in order to communicate users must use the same instant messaging client. For example, if user A is using instant messaging client B and user C is using instant messaging client D they will not be able to communicate as the protocol is different between the two clients. This is restrictive and troublesome for users as all the user's contacts must use the same client or the user must install multiple clients and switch between the programs in order to communicate with their various contacts.

Furthermore, a user must add other users to their contact list in order to communicate with them. This limits the scope or number of people that a user can communicate with restricting the user's instant messaging network to only users that the user knows personally.

Additionally, many instant messaging services require users to have an email account with the company that produces the instant messaging client. This forces users to create email accounts with numerous email service providers that are only used for the instant messaging service. Unfortunately, the user's email name may not be available at all email services which causes the user to have to remember details of numerous email accounts.

Therefore, there is need for an improved instant messaging exchange system that allows users to communicate with others including strangers without divulging the user's identities.

### SUMMARY OF THE INVENTION

To achieve these and other advantages and in order to overcome the disadvantages of the conventional method in accordance with the purpose of the invention as embodied and broadly described herein, the present invention provides a location based anonymous instant messaging system that protects a user's personal identity while allowing numerous users to communicate with each other without being acquainted.

An object of the present invention is to provide a location based instant message exchange system that allows a user to position their current or desired target location, select their broadcasting location criteria, and broadcast their message without knowing the recipients' instant messenger identification. The recipients can reply to the message based on the location without disclosing their actual personal identification to the original message issuer.

Users of the system of the present invention select geographic locations that they are knowledgeable about and select topics that they are interested in. In the future they will receive instant messages relevant to the selected locations and topics from other users. Recipients of the instant message can choose to reply to the message without disclosing their personal identification. This allows users to communicate anonymously via current instant message service.

A user selects a geographical location and topic relevant to a request for information. The user then sends the information request or question to a message bot. A user geographic and topic matching system provides an active matching users list to the message bot. The active matching users list is data comprising the instant messenger identifications of active users who have elected to receive messages regarding the selected location or topic. The message bot then sends the information request message or question to all of the matching users.

The matching users receive and read the information request from the message bot that was sent by the original user. If a user chooses to reply to the message, the user sends their response to the message bot. The user geographic/topic matching system provides the original question issuer's instant messenger identification to the message bot. The message bot sends the reply to the information request to the original question issuer.

Since the users do not communicate directly, the user's personal identification is kept confidential. The sender's identification is removed from the message bot when the matching users list is received and the replier's identification is removed when the message bot receives the sender's identification in order to deliver the response. This confidentiality allows users to easily communicate with each other even though they may not know each other.

The user devices in the system of the present invention comprise desktop computers, notebook computers, mobile devices, personal digital assistants (PDA), and cellular telephones. Communication is performed via a wired network, the internet, a wireless network, a cellular network, a wi-fi network, or a combination of these networks. An advantage of the present invention is the flexibility provided by allowing users to use a variety of electronic devices with various types of networks.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings:

FIG. 1A is a drawing illustrating an information request broadcasting system according to an embodiment of the present invention;

FIG. 1B is a flowchart illustrating a method for anonymously requesting information according to an embodiment of the present invention;

FIG. 2A is a drawing illustrating a response broadcasting system according to an embodiment of the present invention;

FIG. 2B is a flowchart illustrating a method for anonymously replying to an information request according to an embodiment of the present invention;

FIG. 3A is a drawing illustrating an instant messenger interface with map according to an embodiment of the present invention;

FIG. 3B is a flowchart illustrating a method for anonymously broadcasting an information request, anonymously replying to the information request, and continuing an anonymous instant messenger conversation according to an embodiment of the present invention;

FIG. 4 is a drawing illustrating an instant messenger interface according to an embodiment of the present invention; and

FIGS. 5A and 5B are drawings illustrating a tabbed instant messenger interface according to an embodiment of the present invention.

### DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

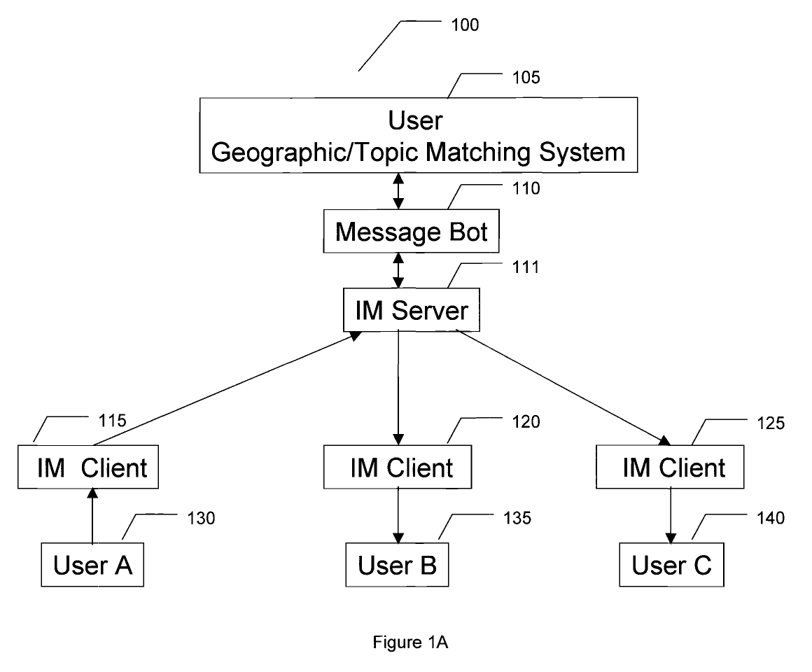

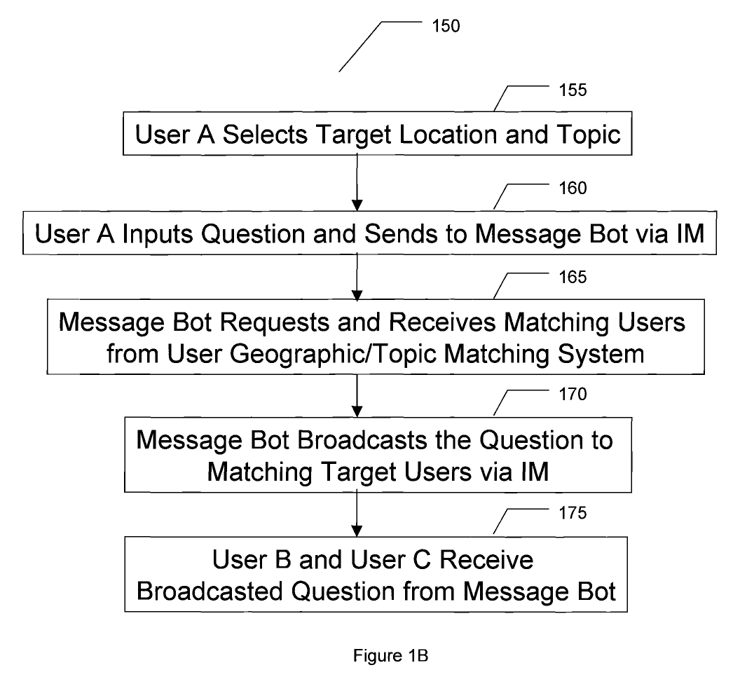

Refer to FIG. 1A, which is a drawing illustrating an information request broadcasting system according to an embodiment of the present invention.

As shown in FIG. 1A, the information request broadcasting system 100 of the present invention comprises a user geographic and topic matching system 105. The user geographic and topic matching system 105 comprises a database of user information, for example user instant messenger identification, user geographic locations of interest, user topics of interest, and user online status.

A plurality of users, user A 130, user B 135, and user C 140 use instant messenger clients 115, 120, and 125 respectively to an instant message server 111 over the Internet. A message bot 110 communicates between the users via an instant message server 111 and the user geographic and topic matching system 105.

Refer to FIG. 1B, which is a flowchart illustrating a method for anonymously requesting information according to an embodiment of the present invention.

The method for anonymously requesting information 150 of the present invention begins with user A making a selection of his target location in Step 155. In an embodiment of the present invention the user also selects a topic relevant to the information request. In an embodiment of the present invention the user only selects the target location. In Step 160 user A requests information and sends the request to the message bot via his instant messenger client. The message bot requests and receives from the geographic and topic matching system a list of users that match the target location and topic in Step 165. In Step 170 the message bot broadcasts the information request to the matching users. The matching users receive the broadcasted request from the message bot in Step 175.

For an example of application of the method the following scenario is given. A user, user A needs information about a certain topic for a specific geographic location. For example, user A is unfamiliar with the surroundings they are in and want to find a good restaurant nearby. User A selects their current location and selects the restaurant topic. User A then enters the question about finding a restaurant in their instant messenger client and sends the question to the message bot. Other users have previously set up their personal preferences regarding what geographic locations and topics they are interested in or have knowledge about. These preferences are stored in the user geographic and topic matching system. The message bot requests a list of active users that match the location and topic selections of the question. The user geographic and topic matching system provides a list of instant messenger identification of users who match. The message bot then broadcasts the question to all the matching users in the list.

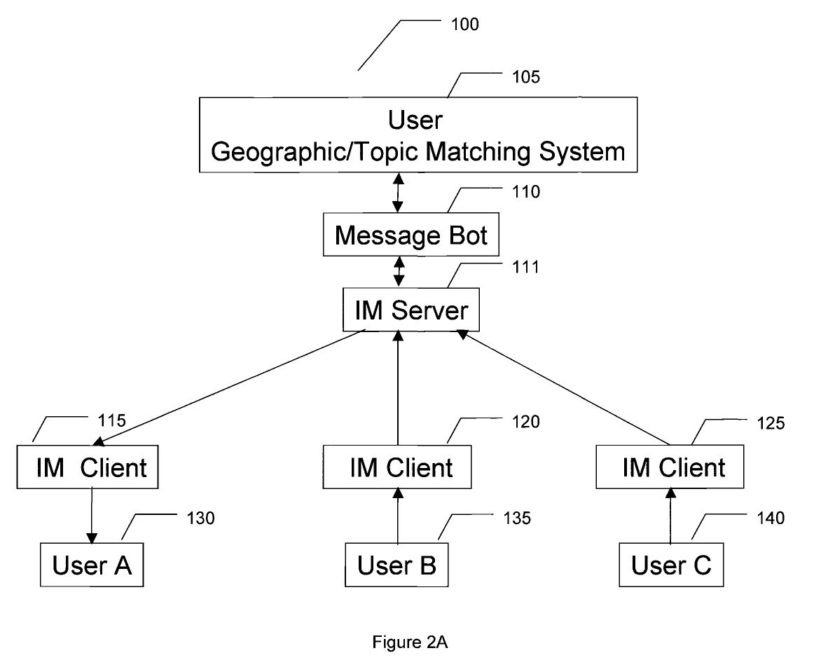

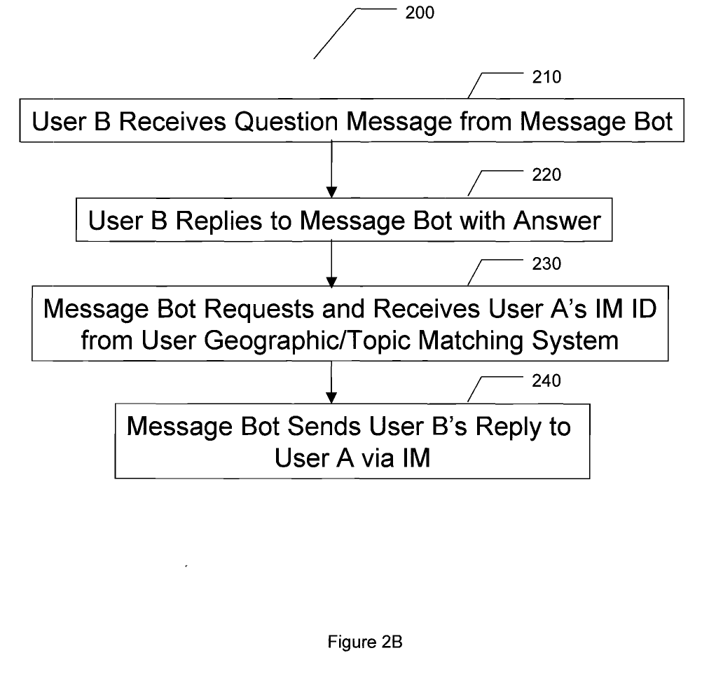

Refer to FIG. 2A, which is a drawing illustrating a response broadcasting system according to an embodiment of the present invention.

As shown in FIG. 2A the response broadcasting system 100 comprises the same elements as illustrated in FIG. 1A but the communication directions are shown for a response or reply broadcast rather then an information request broadcast.

Refer to FIG. 2B, which is a flowchart illustrating a method for anonymously replying to an information request according to an embodiment of the present invention.

The method 200 begins in Step 210 when a second user receives the information request message from the message bot originally sent by a first user. In Step 220, the second user writes their answer or response and sends it to the message bot via their instant messenger client. The message bot requests and receives the original information requester's instant messenger identification from the user geographic and topic matching system in Step 230. In Step 240 the message bot passes the response to the original information request to the original information requester.

Continuing on with the previously described scenario, a user, user B receives the question about finding a restaurant. User B knows the area well and writes a reply containing information for a favorite restaurant in the original user's geographical area and sends the reply to the message bot. The message bot then gets the instant messenger identification of the user that asked the question from the user geographic and topic matching system and delivers the reply message to the original user.

Since the users don't know the instant messenger identification of each other they feel safe to ask for information and provide information while remaining anonymous. In this way, users can ask for and get information from people they don't know but are knowledgeable about a specific location and topic. This greatly expands the user's network as well as increases the efficiency and effectiveness of information gathering by providing instant message requests and replies. Additionally, more than one user may reply to the request thus giving the requester additional information.

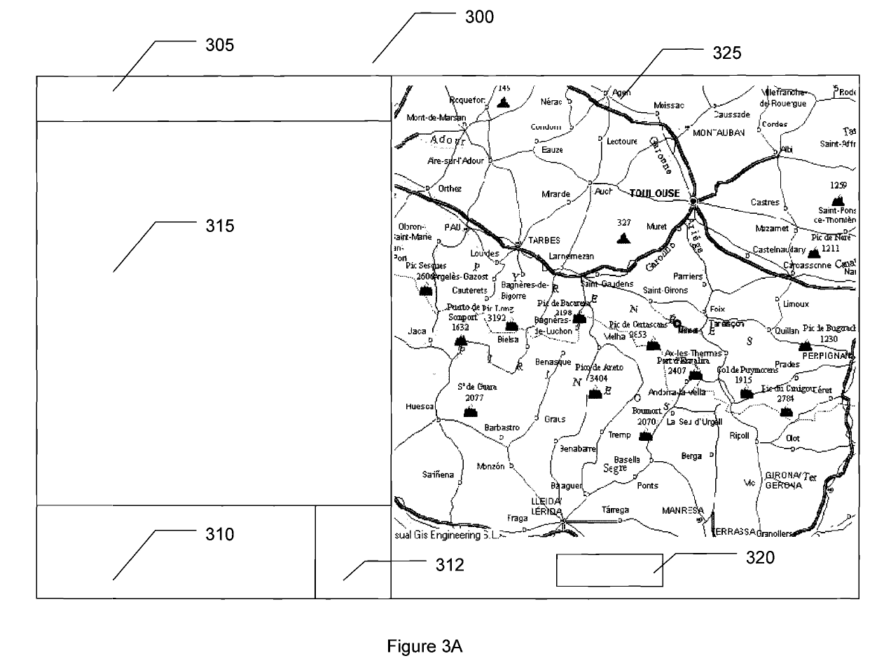

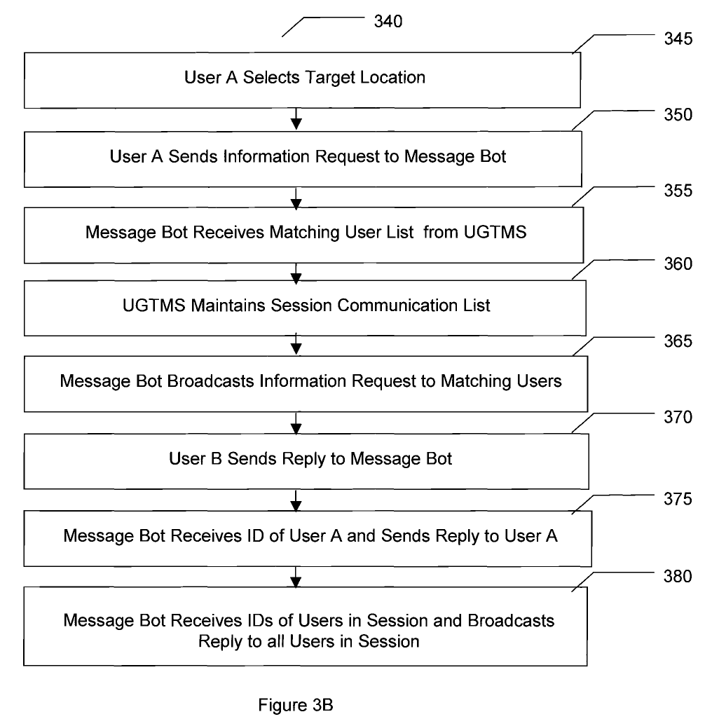

Refer to FIG. 3A, which is a drawing illustrating an instant messenger interface with map according to an embodiment of the present invention.

As illustrated in FIG. 3A, the instant messenger interface 300 of the present invention comprises a toolbar 305, a text input box 310, a dialog box 315, and a map display 320. The toolbar 305 comprises a plurality of tool icons that activate various commands that perform various functions. The text input box 310 is where a user types in a request for information or a response. After the user has entered text in the text input box 310 the message is sent by selecting a send icon 312. The information request and responses are displayed in the dialog box 315 which is continuously updated as communication is sent or received.

A map is displayed in the map display 320. The resolution of the map is varied by navigation controls 325. For example, the map navigation controls comprise zoom in, zoom out, left, right, up, and down. This allows users to easily locate a target location.

In an embodiment of the present invention a topic list is displayed in the dialog box which allows users to easily select a topic for the information request.

Refer to FIG. 3B, which is a flowchart illustrating a method for anonymously broadcasting an information request, anonymously replying to the information request, and continuing an anonymous instant messenger conversation according to an embodiment of the present invention.

In the embodiment illustrated in FIG. 3B users are able to continue an anonymous instant messenger conversation after the initial information request and response.

The method 340 of the present invention begins with a first user making a selection of his target location in Step 345. In an embodiment of the present invention the user also selects a topic relevant to the information request. In Step 350 the first user inputs a request for information and sends the request to the message bot via his instant messenger client. The message bot requests and receives from the user geographic and topic matching system (UGTMS) a list of users that match the target location and topic in Step 355. In Step 360 the user geographic and topic matching system maintains a communication list comprising the instant messenger identifications of the first user and the matching users as well as information regarding the flow of communication. The information request is also given a specific identification and associated with the current communication or instant messenger session. In Step 365 the message bot broadcasts the information request to the matching users and the matching users receive the broadcasted request from the message bot.

In Step 370, the second user writes their answer or response and sends it to the message bot via their instant messenger client. The message bot requests and receives the original information requester's instant messenger identification from the user geographic and topic matching system and sends the reply to the original user in Step 375. In Step 380 the message bot receives the instant messenger identifications of the other matching users and passes the response to the original information request to the other matching users who received the original information request.

If the first user wants further information or clarification about the response, the first user sends an instant message to the message bot. The message bot again receives a list of the matching users in the current session and the message bot broadcasts the instant message to all the matching users. Other matching users can comment or respond to the conversation such as, for example, offering alternatives, disagree with other messages, or providing additional information. This communication exchange continues until the dialog is complete.

If a user doesn't want to participate in the session they can easily exit the exchange or session. When a user exits the session the user geographic and topic matching system removes the user's identification from the communication list for the session.

In an embodiment of the present invention the session is ended by the user who sent the original information request. In another embodiment of the present invention the session ends when the last user exits the session. In another embodiment of the present invention the session ends after a period of inactivity. For example, the session automatically ends after a predetermined amount of time has passed without any messages being sent.

In an embodiment of the present invention the message bot receives the information request from the original user and receives the identification of the first user on the matching user list. The message bot then sends the information request to the first user. The message bot then receives the identification of the second user on the matching user list and sends the information request to the second user. This continues until the information request has been sent to all users on the matching user list. Similarly, when a user sends a reply to the message bot, the message bot receives the identification of the original user and sends the reply to the original user. Then the message bot receives the identification of the first user on the matching user list and sends the first user the reply. The message bot then receives the identification of the second user on the matching user list and sends the reply to the second user. This continues until the reply has been sent to all users on the matching user list. In this embodiment all users in the session are treated similar to the original user.

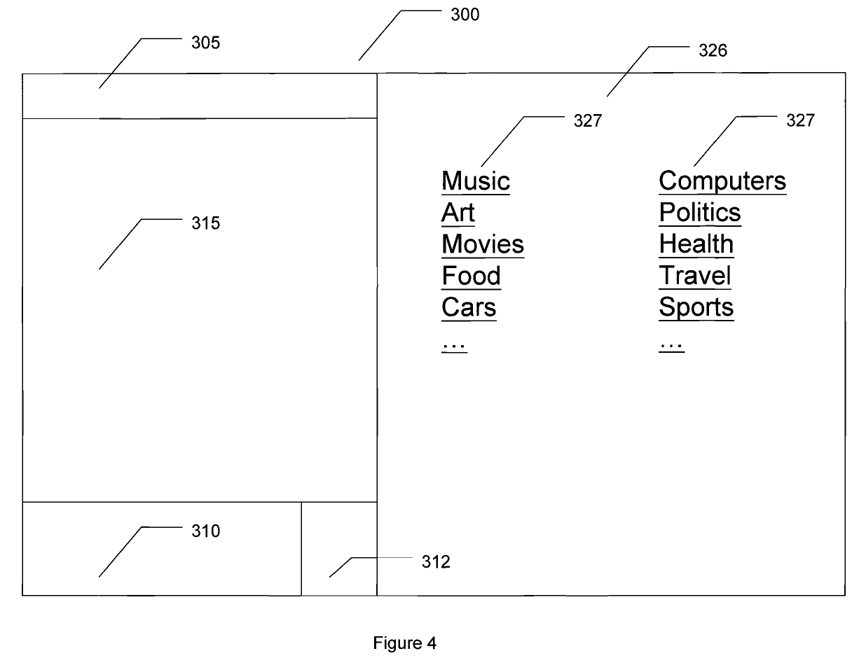

Refer to FIG. 4, which is a drawing illustrating an instant messenger interface according to an embodiment of the present invention.

In the embodiment of the present invention illustrated in FIG. 4 the instant messenger interface 300 further comprises an internet forum window 326. The internet forum window 326 comprises a plurality of topic headings 327 that are linked to forums with a list of threads relevant to the topics. For example, a topic heading “Sports” is linked to threads relating to sports. When a user selects a topic heading they are presented with a list of threads in the forum window. Users can navigate through the forum by selecting threads to view.

In an embodiment of the present invention when the instant messenger session ends, the entire session conversation is automatically added to the forum as a new thread. The thread is located under the correct topic heading by using the topic that the user used when sending the original information request.

In an embodiment of the present invention the session is saved as a thread in the forum by the user who started the session.

In an embodiment of the present invention the session conversation is automatically split into separate posts by user so that the thread comprises the original post and a sequence of responses from all the participating users in individual posts.

The present invention integrates the instant messenger exchange system with an internet forum. The forum is continuously updated with new conversations and threads. The present invention provides an effective real-time instant messaging information gathering service and a valuable archive of previous communications and information. Users can post additional information or comments in the forum in threads of sessions that they didn't originally participate in.

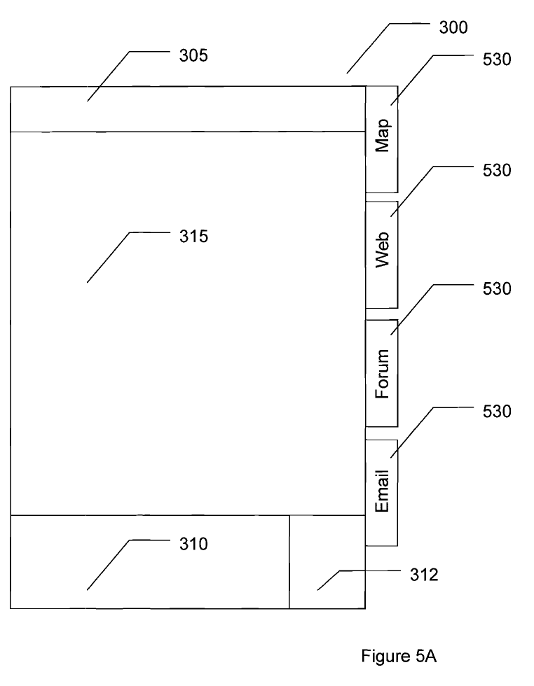

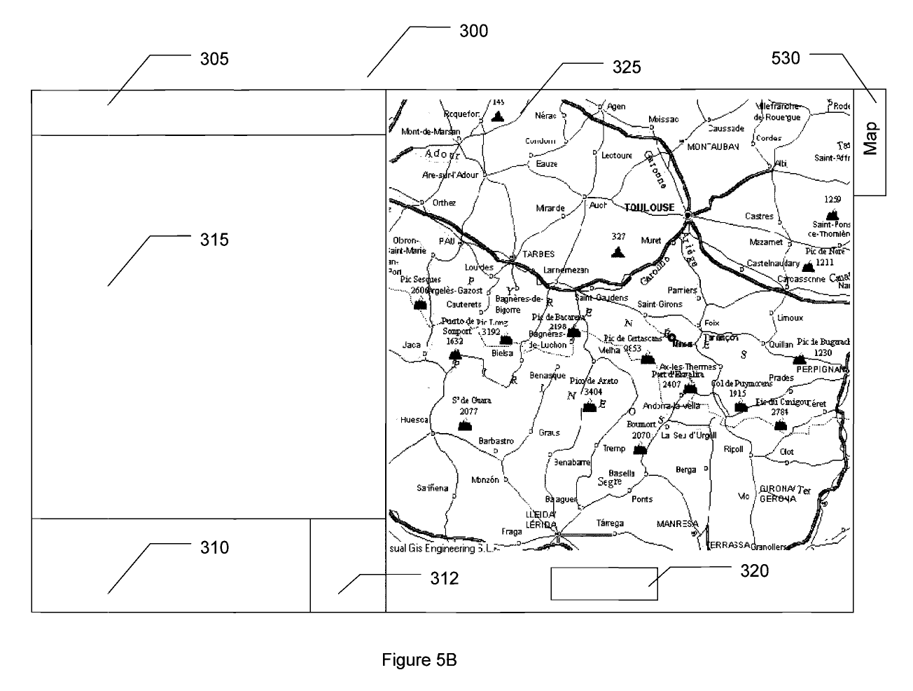

Refer to FIG. 5A and FIG. 5B, which are drawings illustrating a tabbed instant messenger interface according to an embodiment of the present invention.

In the embodiment illustrated in FIGS. 5A and 5B, the instant messenger interface 500 comprises a plurality of tabs 530. When a tab is selected the associated function window appears. For example, when the “Map” tab is selected the map window 525 appears and the map is displayed. When the “Forum” tab is selected the forum window appears and the topics heading page is displayed. When the “Web” tab is selected a browser window appears and the internet can be navigated. When the “Email” tab is selected an email client window appears.

The tabbed instant messenger interface of the present invention provides an efficient and effective method of increasing usefulness while preserving screen real estate. When functions aren't needed the windows disappear leaving only the instant messenger window open and the tabs visible.

In an embodiment of the present invention, the windows slide out from the instant messenger interface when the tab is selected and retract when another function is selected or the tab is selected again.

In an embodiment of the present invention, when a user responding to the information request includes a uniform resource locater URL in their reply, the web tab opens and the website is displayed. This allows users to quickly view websites that are referenced in the reply.

In an embodiment of the present invention, the location of the user requesting information is automatically determined by global positioning satellite. This eliminates the need for a user to enter their target location.

In an embodiment of the present invention the location of all users is determined by global positioning satellite. In this embodiment the location of the user requesting information is determined and the user geographic

In an embodiment of the present invention a topic list is displayed in the dialog box. The user can simply select a topic from the list, input the topic text, or input a number relating to the topic.

In an embodiment of the present invention locations displayed on the map are directly selectable and do not require text input.

In an embodiment of the present invention the broadcast area or size is selected by the user originating the request for information.

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

What is claimed is:

1. A method for anonymously exchanging messages comprising:
receiving an information request from a first user, the information request specifying a geographic location;
determining users associated with the geographic location;
sending the information request to users associated with the geographic location;
receiving a reply to the information request from a second user; and
sending the reply to the first user.

2. The method for anonymously exchanging messages of claim 1, the information request further specifying a topic.

3. The method for anonymously exchanging messages of claim 2, where the information request is sent to users who match the geographic location and topic.

4. The method for anonymously exchanging messages of claim 1, where users and a message bot communicate via instant messenger clients.

5. The method for anonymously exchanging messages of claim 1, where the geographic location is determined by global positioning satellite.

6. The method for anonymously exchanging messages of claim 1, where the geographic location is selectable on a map.

7. The method for anonymously exchanging messages of claim 1, further comprising:
receiving a response to the reply from the first user;
determining identity of the second user; and
sending the response to the second user.

8. A method for anonymously exchanging instant messages comprising:
receiving an information request from a first user by a message bot, the information request specifying a geographic location;
receiving a list of users associated with the geographic location from a user matching system by the message bot;
sending the information request to users on the list by the message bot;
receiving a reply to the information request from at least one user on the list by the message bot;
receiving identity of the first user from the user matching system by the message bot; and
sending the reply to the first user by the message bot.

9. The method for anonymously exchanging instant messages of claim 8, the information request further specifying a topic.

10. The method for anonymously exchanging instant messages of claim 9, where the information request is sent to users associated with the geographic location and topic.

11. The method for anonymously exchanging instant messages of claim 8, where the geographic location is determined by global positioning satellite.

12. The method for anonymously exchanging instant messages of claim 8, where the geographic location is selectable on a map.

13. The method for anonymously exchanging instant messages of claim 8, further comprising:
receiving a response to the reply from the first user;
determining identity of the at least one user on the list who sent the reply; and
sending the response to the at least one user who sent the reply.

14. A method for anonymously exchanging instant messages comprising:
selecting a geographic location by a first user;
inputting an information request by the first user;
sending the information request to a message bot by the first user;
receiving a matching user list from a user geographic matching system by the message bot; and
sending the information request to users on the matching user list by the message bot.

15. The method for anonymously exchanging instant messages of claim 14, further comprising:
inputting a reply to the information request by a second user, the second user being on the matching user list;
sending the reply to the message bot by the second user;
receiving identity of the first user from the user geographic matching system by the message bot; and
sending the reply to the first user by the message bot.

16. The method for anonymously exchanging instant messages of claim 14, further comprising:
selecting a topic by the first user.

17. The method for anonymously exchanging instant messages of claim 16, where the information request is sent to users who match the geographic location and topic.

18. The method for anonymously exchanging instant messages of claim 14, the matching user list comprising identities of users associated with the geographic location.

19. The method for anonymously exchanging instant messages of claim 14, where the geographic location is selectable on a map.

20. The method for anonymously exchanging instant messages of claim 15, further comprising:
receiving a response to the reply from the first user by the message bot;
determining identity of the second user by the user geographic matching system; and
sending the response to the second user by the message bot.
